(19) United States
(12) Patent Application Publication
(10) Pub. No.: US 2006/0288533 A1
(43) Pub. Date: Dec. 28, 2006

(54) Hinge structure using magnetic force and image input/output device using the hinge

(75) Inventor: Dong-gyoo Lee, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/475,020

(22) Filed: Jun. 27, 2006

(30) Foreign Application Priority Data
Jun. 28, 2005 (KR) 10-2005-0056203

(51) Int. Cl. E05D 11/10

(52) U.S. Cl. 16/330

(57) ABSTRACT

A hinge structure is provided. The hinge structure uses a magnetic force and includes a shaft, provided at one side of a cover and rotatably supported by a body. At least one permanent magnet having a magnetic field perpendicular to the longitudinal direction of the shaft is fixed to the shaft. A shaft operation portion is provided in the cover for rotating the shaft by about 180 degrees and rotating between a first position and a second position by a user's operation. At least one electromagnet is arranged at a position corresponding to the permanent magnet of the body, thereby aiding the opening and closing of the cover and absorbing any impact using a magnetic force between the permanent magnet and the electromagnet.

### CROSS-REFERENCE TO RELATED PATENT APPLICATION

This application claims the benefit of Korean Patent Application No. 10-2005-0056203, filed on Jun. 28, 2005, in the Korean Intellectual Property Office, the disclosure of which is incorporated herein by reference in its entirety.

### BACKGROUND OF THE INVENTION

1. Field of the Invention

The present invention relates to a hinge structure. More particularly, the invention relates to a hinge structure comprising a body and a cover, wherein the cover can be easily opened and smoothly closed with a buffering effect by rotating upward and downward.

2. Description of the Related Art

Generally, a hinge structure connects two parts of a device to rotate about one shaft, and can include a structure for aiding the rotation or resistance against rotation, as needed.

In electronic devices such as copiers, scanners, etc., there are many devices having a cover which opens upwardly. This sort of cover not only requires a greater force for opening, due to gravity, but is also likely to create impact upon closing due to the acceleration of gravity. Especially when the cover is provided with an additional device, such as an automatic feeder in the cover of a copier, the extra weight may cause an impact damage to the cover and the body. Therefore, there is a need for a hinge structure which buffers impact by applying a suitable reactive force when the cover is closed.

To meet such a need, the conventional hinge structure uses a cam member which is pressed by the force of a spring. However, this conventional hinge structure is likely to generate noise by friction against the cam member, and to wear quickly since it requires a strong spring.

### SUMMARY OF THE INVENTION

The present invention provides a hinge structure which allows a cover to be easily opened and smoothly closed by rotating upward and downward. The hinge structure buffers impact upon closing of the cover while reducing noise by using a magnetic force. The result is a hinge structure having improved durability.

In an aspect of the present invention, a hinge structure is provided using a magnetic force, in which a cover is opened and closed relative to a body by rotation about a shaft. The hinge includes a shaft on a side of the cover and is rotatably supported by the body. At least one permanent magnet having a magnetic field perpendicular to the longitudinal direction of the shaft is fixed with respect to the shaft. A shaft operation portion is provided in the cover and manipulated by a user to rotate the shaft by about 180 degrees and return the shaft to the original position. At least one electromagnet is arranged in the body at a position corresponding to the permanent magnet and selectively generates upward and downward magnetic fields. A sensor senses the opening and closing of the cover. A controller controls current applied to the electromagnet by receiving a signal from the sensor.

In the hinge structure according to the present invention, the cover may be locked by an attractive force between the permanent magnet and the electromagnet at an initial stage where the cover is closed, and a repulsive force between the permanent magnet and the electromagnet aids opening of the cover, and buffers impact between the cover and the body when the cover is closed.

The shaft may be arranged such that the magnetic field of the permanent magnet may be formed in substantially coaxial direction with respect to the magnetic field of the electromagnet at an initial state where the cover is closed and the shaft operation portion is not manipulated. In this case, the controller may apply current to the electromagnet such that an attractive force is exerted between the permanent magnet and the electromagnet.

The shaft operation portion may include a mechanism or structure capable of reversing the magnetic field of the permanent magnet by rotating the shaft by about 180 degrees, by means of a simple lever, when a user wants to open or close the cover. This may be realized by a combination of a link, a gear, a cam, and similar such elements. It should be noted that this mechanism or structure is not limited to one or two types, and a person having ordinary knowledge and skill in the art will understand that this mechanism structure could be realized in numerous other ways.

In another aspect of the present invention, an image forming apparatus is provided including the above-described hinge structure using a magnetic force, in which the hinge structure is opened and closed as its body and cover are rotated about the shaft.

An image forming apparatus may be a scanner, copier, facsimile machine, printer, or a combination of these devices. In an optical device such as a copier or scanner, a cover is necessary to prevent light from being unnecessarily emitted. Therefore, the image forming apparatus according to the present invention applies the hinge structure using the magnetic force according to the present as the hinge structure for opening and closing the cover of the image forming apparatus.

These and other aspects of the invention will become apparent from the annexed drawings and the detailed description of the invention which disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a hinge structure according to an embodiment of the present invention; and

FIGS. 2A to 2D show the operation of the hinge structure according to the present invention.

### DETAILED DESCRIPTION OF THE INVENTION

The present invention will now be described more fully with reference to the accompanying drawings.

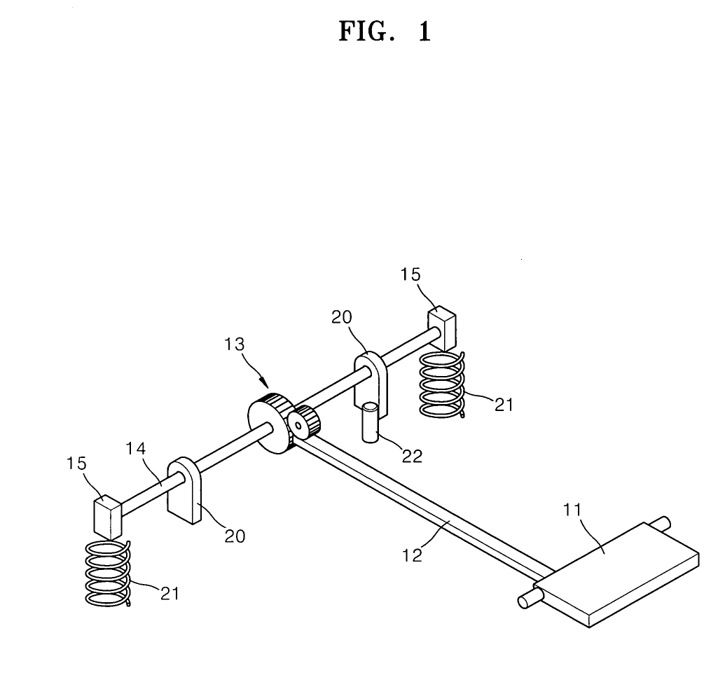

FIG. 1 is a perspective view of a hinge structure according to an embodiment of the present invention. For the convenience of understanding, only functional elements of the hinge structure are shown in FIG. 1.

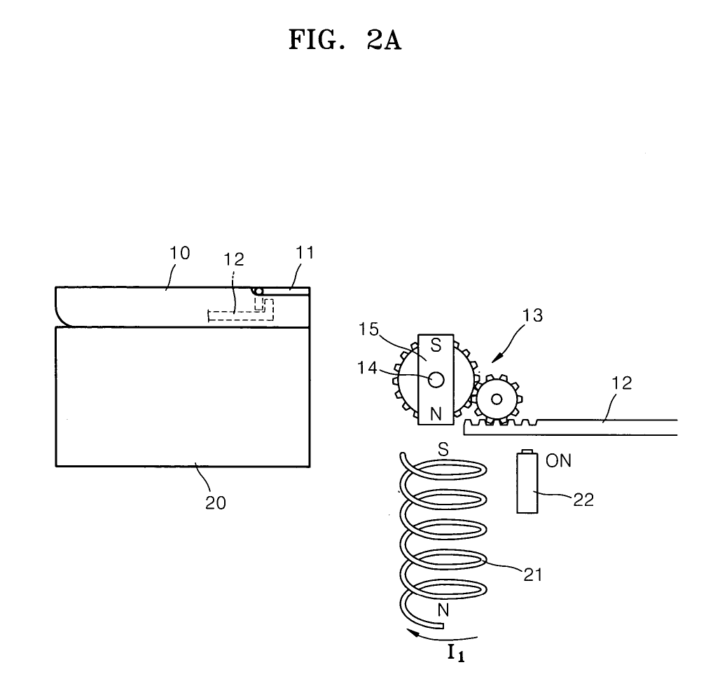

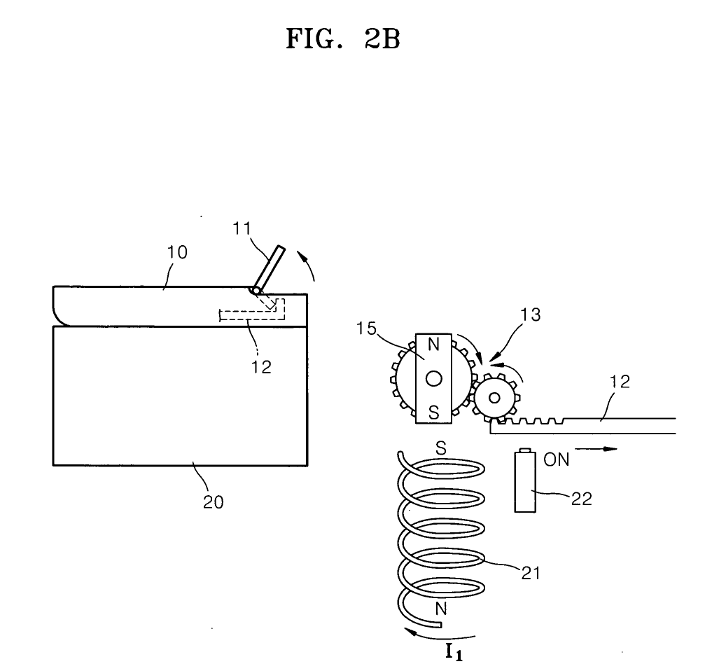

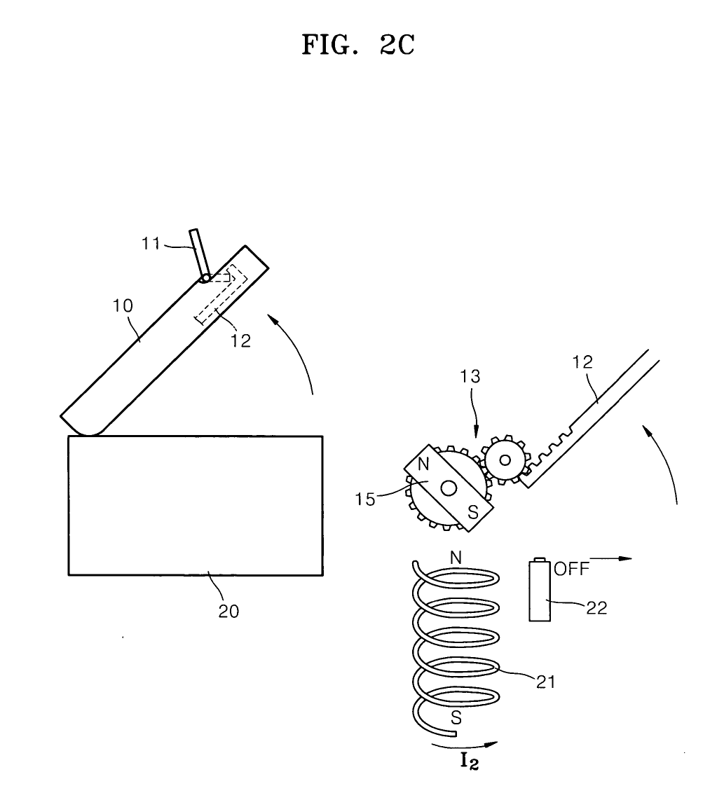

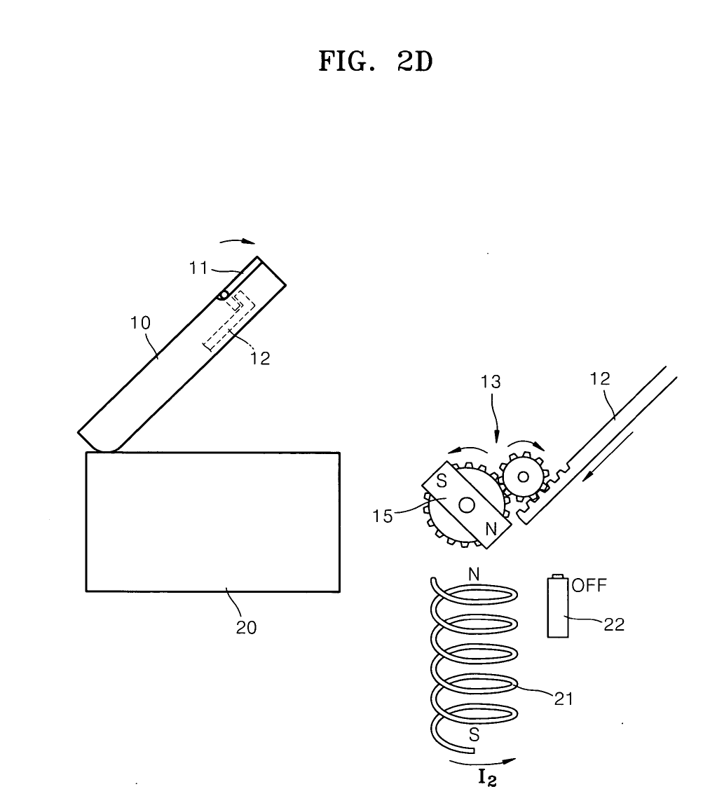

A shaft 14 is provided on a side of the cover 10 shown in FIG. 2A, and a shaft operation portion is provided between an opposite side of the cover and the shaft as a mechanism for rotating shaft 14 by about 180 degrees. According to the present embodiment, the shaft operation portion may include a lever 11, a link member 12 and a gear train 13. The lever 11 is provided on the opposite side of the cover from the gear train 13 and is arranged to rotate by a predetermined angle relative to the cover by a user's manipulation. The link member 12 has a first end connected to the lever 11 and a second end connected to the gear train 13. The gear train 13 is provided between the link member 12 and the shaft 14.

The shaft operation portion may be different to the description given here, but it is preferable that when the lever 11 is rotated by the user, the link member 12 linearly moves and the gear train 13 converts the linear movement of the link member 12 into a rotation movement to be transferred to the shaft 14. The connection of the link member 12 and the gear train 13 may be formed by a rack and pinion.

The shaft 14 is rotatably supported by a body 20 and is rotatable relative to the cover 10. A permanent magnet 15 is fixed to the shaft 14 (for example, both ends of the shaft 14). The angle of rotation of the shaft 14 by the shaft operation portion is determined by the layout of various elements, and is preferably about 180 degrees, so that the orientation of the magnetic field of the permanent magnet 15 fixed on the shaft 14 is reversed by the rotation of the shaft 14. Although the angle of rotation may be slightly more or less than 180 degrees, this is allowable if it does not affect the function of the hinge structure as described below.

An electromagnet 21 is provided in the body 20 at a position corresponding to the location of the permanent magnet 15, and a sensor 22 for sensing the opening and closing of the cover 10 is provided in the body 20 or at one side of the cover 10. The sensor 22 may be any one of various sensors which can sense whether the body 20 and the cover 10 contact each other or are close to each other. For example, a contact switch may be employed. The sensor produces a signal when the cover is in a closed position and a signal when the cover is in the open position.

Although not shown in FIG. 1, the hinge structure according to the present invention further comprises a controller electrically connected to the sensor 22 and the electromagnet 21. The controller applies the required current such that the upward or downward magnetic field may be selectively formed in the electromagnet 21, and controls the current applied to the electromagnet 21 in accordance with a signal input from the sensor 22. The sensor is not necessarily included, and the controller for controlling the main functions of an electronic device to which the hinge structure is applied may be used.

The features of the present invention will be further explained in detail below through the operation of the hinge structure according to the present invention.

FIGS. 2A through 2D show the operation of the hinge structure according to the present invention. FIG. 2A shows an initial stage where the cover 10 is closed and the lever 11 of the shaft operation portion is not operated yet. On the right of each of these, the main operation parts of the hinge structure are shown in a simplified side view.

At the initial stage when the shaft 14 and the permanent magnet are in a first position, the magnetic fields of the permanent magnet 15 and the electromagnet 21 are oriented in the same direction a shown in FIG. 2A. That is, when the permanent magnet 15 has a downward pole (depicted as N), the controller (not shown) applies current I₁ to the electromagnet 21 in a direction such that the electromagnet 21 also has a downward pole (depicted as N). Then, the sensor 22 maintains an ON state since the cover 10 contacts the body 20 in a closed position.

FIG. 2B shows the lever 11 operated as indicated by the arrows after the initial stage. When the lever 11 is rotated, the link member 12 moves in the direction of the arrow. The end of the link member 12 includes a rack gear connected to the gear train 13 to rotate the gear train 13. The gear train 13 rotates the shaft and the permanent magnet 15 by about 180 degrees to a second position. Then, the cover 10 is rotated about the shaft and starts opening, and the force of repulsion between the electromagnet 21 and the permanent magnet 15 can aid the opening operation of the cover.

FIG. 2C shows the cover 10 opened in the direction of the arrow. Herein, the sensor 22 for sensing whether the cover 10 and the body 20 contact each other generates an OFF signal, and the controller (not shown) applies current I₂ such that the magnetic field of the electromagnet 21 is reversed, in response to the signal. Although an attractive force is generated between the permanent magnet 15 and the electromagnet 21, the influence on the operation of the cover 10 is not great since the distance between the poles is relatively great. As depicted in FIG. 2C, the electromagnet has a magnetic field opposite to the orientation shown in FIGS. 2A and 2B and opposite the field of the permanent magnet shown in FIG. 2C.

FIG. 2D shows the lever 11 of the opened cover 10 returning to its original position. By returning the lever 11 to its original position, the link member 12 and the gear train 13 are moved in the direction of the arrows to rotate the permanent magnet 15 by about 180 degrees in the direction opposite to that of FIG. 2B and to the first position shown in FIG. 2A. Then, the force of repulsion is generated between the permanent magnet 15 and the electromagnet 21 to resist a rapid drop of the cover 10 against the body and absorb any impact. As the cover 10 approaches the body 20, the distance between the poles of the permanent magnet 15 and the electromagnet 21 is shorter, so that the impact of the cover 10 can be effectively absorbed at the moment when the cover 10 reaches the body 20.

Now, although the force of repulsion acts to rotate the permanent magnet 15 counter-clockwise in FIG. 2d, the permanent magnet 15 cannot be rotated since the lever 11 and the ink chamber 12 are stopped at an initial position. In addition, the force of repulsion may be transferred to the cover 10 itself without rotating the permanent magnet 15 by the reduction ratio of the gear train 13.

Likewise, when the cover 10 is closed such that the controller 22 again generates an ON signal, the controller (not shown) again changes the direction of the current applied to the electromagnet 21, so that the cover 10 is locked. At this time, it is preferable that the controller controls the electromagnet 21 with a time delay after a new signal is input from the sensor 22. Thereby, it is possible that the hinge structure according to the present invention fully absorbs all impact until the cover 10 is completely closed, and aids the opening of the cover 10 by the force of repulsion until it is completely open.

Further, in the case of combining the hinge structure using the magnetic force of the present invention and the image forming apparatus, the constitution and operation are the same as described above.

The hinge structure using the magnetic force according to the present invention has the effects of aiding the opening of the cover by the technical constitution as described above, and absorbing impact upon closing the cover. There are also the effects of significantly reducing noise by using the magnetic force when the hinge structure is operated, and improving durability.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A hinge structure using magnetic force, in which a body and a cover are opened and closed by rotation about a shaft, the hinge comprising:
the shaft positioned on a side of the cover and being rotatably supported by the body, and at least one permanent magnet having a magnetic field perpendicular to the longitudinal direction of the shaft fixed to the shaft;
a shaft operation portion provided in the cover and being manipulated by a user to rotate the shaft and the permanent magnet about 180 degrees and rotate the shaft from a first position to a second position;
at least one electromagnet arranged in the body at a position corresponding to the permanent magnet to selectively generate upward and downward magnetic fields with respect to the permanent magnet;
a sensor for sensing opening and closing of the cover; and
a controller for controlling an electrical current applied to the electromagnet by receiving a signal from the sensor.

2. The hinge structure according to claim 1, wherein the shaft operation portion comprises:
a lever rotating relative to the cover over a predefined angle;
a movable link member having a first end connected to the lever and a second end extending to a side of the shaft; and
a gear train coupled to the shaft for converting linear movement of the link member into a rotational movement of the shaft.

3. The hinge structure according to claim 2, wherein the link member comprises a rack gear provided at the side of the shaft.

4. The hinge structure according to claim 1, wherein the shaft is arranged such that the magnetic field of the permanent magnet is formed in substantially coaxial direction with respect to the magnetic field of the electromagnet at the first position where the cover is closed and the shaft operation portion is not manipulated.

5. The hinge structure according to claim 1, wherein the controller applies an electrical current to the electromagnet such that an attractive force is exerted between the permanent magnet and the electromagnet where the permanent shaft is in the first position, the cover is closed and the shaft operation portion is not manipulated.

6. The hinge structure according to claim 5, wherein the controller reverses the direction of the electrical current applied to the electromagnet when a cover opening signal is received from the sensor and changes the direction of the electrical current to the same direction when a cover closing signal is received and the shaft and permanent magnet are in the first position.

7. The hinge structure according to claim 6, wherein the controller has a time delay from the time when the signal is received from the sensor to the time when the current applied to the electromagnet is reversed.

8. An image forming apparatus comprising a hinge structure using magnetic force, in which a body and a cover are opened and closed by rotating about a shaft, comprising:
a shaft provided on a side of the cover and rotatably supported by the body, and having at least one permanent magnet having a magnetic field perpendicular to the longitudinal direction of the shaft fixed to the shaft;
a shaft operation portion provided in the cover and manipulated by a user to rotate the shaft by about 180 degrees from a first position to a second position;
at least one electromagnet arranged in the body at a position corresponding to the permanent magnet to selectively generate upward and downward magnetic fields;
a sensor for sensing an opening and closing of the cover; and
a controller for controlling electrical current applied to the electromagnet by receiving a signal from the sensor.

9. The image forming apparatus according to claim 8, wherein the shaft operation portion comprises:
a lever rotating relative to the cover over a predefined angle;
a movable link member having a first end connected to the lever and a second end extending to the side of the shaft; and
a gear train coupled to the shaft for converting linear movement of the link member into a rotational movement of the shaft.

10. The image forming apparatus according to claim 9, wherein the link member comprises a rack gear provided at the side of the shaft.

11. The image forming apparatus according to claim 8, wherein the shaft is arranged such that the magnetic field of the permanent magnet is formed in substantially coaxial direction with respect to the magnetic field of the electromagnet at the first position where the cover is closed and the shaft operation portion is not manipulated.

12. The image forming apparatus according to claim 8, wherein the controller applies an electric current to the electromagnet such that an attractive force is exerted between the permanent magnet and the electromagnet where the shaft and electromagnet are in the first position, the cover is closed and the shaft operation portion is not manipulated.

13. The image forming apparatus according to claim 12, wherein the controller reverses the direction of the electrical current applied to the electromagnet when a cover opening signal is received from the sensor and changes the direction of the current to the same direction when a cover closing signal is received and the shaft and the permanent magnet are in the first position.

14. The image forming apparatus according to claim 13, wherein the controller has a time delay from the time when the signal is received from the sensor to the time when the current applied to the electromagnet is reversed.
